(19) United States
(12) Patent Application Publication
(10) Pub. No.: US 2022/0230454 A1
(43) Pub. Date: Jul. 21, 2022

(54) OBJECT IDENTIFICATION SYSTEM WITH FLAT CARRIER MEDIUM FOR ARRANGING ON A DEVICE

(71) Applicant: AUDI AG, Ingolstadt (DE)

(72) Inventors: Markus KLUG, Ingolstadt (DE); Tobias MOLL, Ingolstadt (DE); Johannes SCHEUCHENPFLUG, Baar-Ebenhausen (DE)

(73) Assignee: AUDI AG, Ingolstadt (DE)

(21) Appl. No.: 17/608,382

(22) PCT Filed: Apr. 30, 2020
(86) PCT No.: PCT/EP2020/062107

§ 371 Date: Nov. 2, 2021

(30) Foreign Application Priority Data
May 3, 2019 (DE) 10 2019 206 377.2

(51) Int. Cl. G06V 20/59; G06V 10/147; B60R 11/04; G02B 27/09

(52) U.S. Cl. CPC G06V 20/59; G02B 27/0944; B60R 11/04; G06V 10/147

(57) ABSTRACT

An object recognition system includes a two-dimensional carrier medium which can be disposed on a component in a vehicle interior. The carrier medium is configured as a light guide, and a coupling-in region and a coupling-out region are disposed on the carrier medium. Light from a surrounding area is coupled into the carrier medium via the coupling-in region, is transmitted to the coupling-out region by internal reflection, and is coupled out of the carrier medium. The object recognition system further includes an image capturing device to capture the light that is coupled out and provides the light coupled out of the carrier medium in a form of image data. The object recognition system further includes an evaluation device to capture an object in the surrounding area based on the image data, to recognize the object based on an object recognition criterion, and to provide object data describing the object.

### CROSS REFERENCE TO RELATED APPLICATIONS

This application is a U.S. national stage of International Application No. PCT/EP2020/062107, filed on Apr. 30, 2020. The International Application claims the priority benefit of German Application No. 10 2019 206 377.2 filed on May 3, 2019. Both International Application No. PCT/EP2020/062107 and German Application No. 10 2019 206 377.2 are incorporated by reference herein in their entirety.

### BACKGROUND

Described herein is an object recognition system including an evaluation device and at least one capturing device, wherein the at least one capturing device includes at least one image capturing device and a two-dimensional carrier medium for arrangement on a unit. Also described herein is a motor vehicle having a vehicle interior in which one or more object recognition systems may be provided.

To ascertain the type of object that is located in a surrounding area of a unit, different measurement methods can be applied. It is possible to apply a measurement method that is based, for example, on near-field communication or with the aid of an optical sensor, a radar unit, or a proximity-based sensor. A proximity-based sensor is here understood to mean for example an induction measurement device or a pressure sensor. However, a recording position for recording an imaged presentation of the object to be recognized is frequently unsuitably specified, for example in the case of optical sensors. This is the case for example if, based on an image angle of a measurement unit, an imaged presentation of the object is distorted, a recognition distance or a focal plane of the measurement unit is limited, a degree of a resolution of the imaged presentation is too low, an installation space within, for example, a vehicle in which the object is to be captured and recognized is too small for the application of the selected measurement method, or the unit is embodied so as not to be transparent, as a result of which different positions within the motor vehicle, for example at a windshield, cannot be chosen.

U.S. Patent Application Publication No. 2015/0023602 A1 illustrates a system and a method for quickly recognizing and differentiating between different objects. In that case, the object can be recognized with the aid of a sensor of a vehicle operating on a holographic principle.

German Patent Application No. 10 2009 010 904 A1 describes the recognition of an object or of a plurality of objects by recording a temporally coherent object wave field, which is reflected or emitted by the respective object. In that case, an amplitude and phase of the object wave field at a plurality of points of a recording space segment are recorded.

International Patent Application Publication No. WO 00/50267 illustrates person or object recognition in an interior of a vehicle by use of a sensor. In that case, the sensor can be embodied in the form of a camera and can record images of the interior that are then subjected to pattern recognition. Alternatively, the sensor can sample an effective region in the interior of the vehicle by use of optical radiation, for example.

Optical diffraction gratings that are produced holographically and are therefore referred to as holographic gratings are also known. In this regard, it is known from the scientific publication “Volume-phase holographic gratings and their potential for astronomical applications” (S. C. Barden, J. A. Arns and W. S. Colburn, Proceedings SPIE 3355, Optical Astronomical Instrumentation, 1998) that light that is incident on such a holographic grating at an angle that is clearly outside the angular range that meets the Bragg condition passes through the holographic grating without diffraction. However, if light is incident on the holographic grating at an angle such that the Bragg condition is at least approximately satisfied, the light is diffracted at an angle. A similar behavior can be seen with regard to a wavelength dependency of the influence of the holographic grating on light. This is because light having a wavelength that is clearly outside the wavelength range specified by the Bragg condition as the so-called Bragg wavelength likewise passes through the holographic grating without being diffracted, and only light having a wavelength that at least approximately satisfies the Bragg condition is diffracted at the holographic grating. Using complex holographic grating structures, it is thus possible, for example, for light having two different wavelength ranges to be diffracted at the same angle in each case. In addition, a holographic grating can be used, for example, to split light having different wavelengths into different light paths, with the result that a dispersive beam splitter can be implemented with the aid of a holographic grating.

### SUMMARY

Described herein is a solution by which an object in a surrounding area can be captured and recognized over a large-area recording region.

This may be achieved by the object recognition system described herein. Advantageous developments are also disclosed in the following description, drawings, and the claims.

The object recognition system described herein includes an evaluation device and at least one capturing device. The at least one capturing device includes at least one image capturing device and a two-dimensional carrier medium. The two-dimensional carrier medium is designed to be arranged on a unit. The carrier medium is implemented, for example, in the form of a plate or a film (for example made of plastic or glass), wherein the carrier medium transmits light by internal reflection from the surrounding area to the at least one image capturing device. For this purpose, the carrier medium is embodied in the form of a light guide, on which a coupling-in region and a coupling-out region are provided. The carrier medium thus represents a light-guiding medium. It is the carrier of the coupling-in region and of the coupling-out region.

The coupling-in region is embodied in the form of a holographic element with a first deflection structure. The first deflection structure is embodied to couple light that is incident from a surrounding area on the first deflection structure into the two-dimensional carrier medium. A two-dimensional carrier medium in this case refers to a carrier medium whose length and width of a surface is chosen to be particularly large in comparison with a thickness of the carrier medium, which is perpendicular thereto. The coupling-in region includes at least one partial region of the surface of the two-dimensional carrier medium. The first deflection structure of the coupling-in region can be implemented for example in the form of a diffraction grating.

The two-dimensional carrier medium is embodied to transmit the coupled-in light from the coupling-in region to the coupling-out region by internal reflection, for example by total internal reflection. The coupling-out region in turn is embodied in the form of a holographic element with a second deflection structure, which is designed to couple the transmitted light that is incident on the second deflection structure out of the two-dimensional carrier medium. The second deflection structure of the coupling-out region can likewise be implemented for example in the form of a diffraction grating.

The at least one image capturing device, which is embodied to capture the light that is coupled out and to provide it in the form of image data that correlate with the captured light, is arranged at the coupling-out region. The image capturing device is thus oriented to produce or generate image data from the light that is coupled into the capturing device. To capture the light that is coupled out of the carrier medium, the image capturing device abuts the coupling-out region. In order to attach the image capturing device to the carrier medium, the image capturing device can be adhesively bonded to the carrier medium, for example. Alternatively, the carrier medium can be clamped in a holding device of the image capturing device. The image capturing device may be implemented in the form of an image sensor or camera, each with or without an imaging optical unit, such as a lens or a lens system. The image capturing device can be embodied for example in the form of a CCD (charge-coupled device) sensor or of a CMOS (complementary metal oxide semiconductor) sensor. When the image capturing apparatus is designed as an image sensor, the carrier medium at which the coupling-in region and the coupling-out region are arranged can additionally perform the task of an objective, that is to say of an imaging optical unit. Alternatively, the image capturing device can also be implemented in the form of a camera or photographic camera, for example a micro-camera, such as is embodied for example in a mobile unit (smartphone) with its own imaging optical unit. The image capturing device is therefore designed for the photographic and/or video-based generation of an imaged presentation of a surrounding area of the object recognition system.

The object recognition system is thus embodied to record static or moving images, which present an imaged presentation of the surrounding area of the object recognition system. In this case, the light that is incident from the surrounding area on the first deflection structure is coupled into the carrier medium and is guided within the carrier medium in zigzag-like movements in a direction parallel to a plane of the surface of the carrier medium. It is of course a prerequisite here that the capturing device of the object recognition system is positioned in a preferred installation position, that is to say is arranged on the surface of a unit, wherein the side with the coupling-in region is directed in the direction of the surrounding area, whereas the coupling-out region is arranged for example on the opposite side and is arranged for example in the direction of the unit. The coupling-in region and the coupling-out region can alternatively be provided on the same side of the carrier medium.

The entire coupling-in region of the capturing device thus serves as a capturing region for the light, which is ultimately passed on to the image capturing device and is provided there in the form of image data correlated with the light. The coupling-in region thus forms a type of camera sensor for the image capturing device. The coupling-in region here may include an entire surface side of the two-dimensionally embodied carrier medium. This results in the advantage that the capturing region of the object recognition system may include at least one entire side of the two-dimensional carrier medium.

The evaluation device of the object recognition system is then embodied to capture an object in the surrounding area taking into account the image data. It is thus possible to recognize with the aid of the evaluation device whether a contiguous object can be recognized in the image data correlated with the captured light, such as a person, an article, or a symbol displayed for example on a display apparatus in the surrounding area. Moreover, the evaluation device is embodied to recognize the captured object taking into account an object recognition criterion. The object recognition criterion may include, for example, characteristics of different objects stored in a database, such as a typical size, coloration, and shapes, a typical reflection behavior of light at the object, and a typical location-dependent and/or time-dependent arrangement of objects for example within a motor vehicle. Object data describing the recognized object are ultimately provided by the evaluation device. The object recognition can take place based on a machine learning method, for example by use of an artificial neural network.

If the capturing device with the two-dimensional carrier medium is arranged for example on a dashboard of a motor vehicle, it is possible using the object recognition system to capture the face of a driver of the motor vehicle initially in the form of image data, then to recognize the captured object, that is to say the captured face of the driver, taking into account the object recognition criterion, and for example to assign it to a stored profile of the driver, with the result that the driver can be identified. The object data can then include for example a name and further data relating to the recognized driver that are stored in the profile.

For this purpose, the evaluation device has, for example, a processor device, which is configured to perform the described object recognition. To this end, the processor device can have at least one microprocessor or at least one microcontroller. Furthermore, the processor device can have program code, which is configured to perform the described object recognition when executed by the processor device. The relevant program code can be stored in a data memory of the processor device.

Ultimately, a type of camera apparatus is thus implemented by the object recognition system, which includes as the camera sensor the two-dimensional carrier medium with the at least one image capturing device arranged at the coupling-out region and is positionable at any position for example in a motor vehicle interior, and with which image capturing and also object recognition of an object in the captured image data is made possible. For example articles in an interior of the motor vehicle can be captured and recognized. In this case, a recording quality of the image data required is improved in comparison with the above-described alternative possibilities for article recognition, by virtue of the fact that the light is initially coupled into the carrier medium on a large surface and is transmitted by the carrier medium to the image capturing device. This is because in this case, light is coupled from a large recording surface, for example the entire surface of the two-dimensional carrier medium, into the object recognition system, with the result that image capturing takes place not just in a point-wise fashion but over a large area. Such a two-dimensional and, for example additionally transparent, carrier medium can also be integrated inconspicuously at different positions, among them in a windshield of a motor vehicle. The described object recognition system is thus usable in a wide variety of ways within a surrounding area, such as for example a motor vehicle.

Also described herein are embodiments resulting in additional advantages.

One embodiment makes provision for the coupling-in region and the coupling-out region to have, as a deflection structure, at least one optical grating, for example a surface holographic grating or a volume holographic grating. In this context, the capturing device can also be referred to as a HoloCam, short for holographic camera.

As already mentioned, an optical grating, also referred to as a diffraction grating, and its mode of action and production method are generally known, as is evident, for example, from the scientific publication cited above. In principle, an optical grating can be based on at least partially periodic structures, what is known as a grating structure, in a substrate. By use of such a grating structure, an optical grating can bring about, through the physical effect of diffraction, light guidance, as is known, for example, from mirrors, lenses, or prisms. If light is, that is to say if light rays are, incident on the optical grating, wherein the incident light rays in particular satisfy the Bragg equation, the light rays are diffracted or deflected by the optical grating. The light can thus be guided for example by interference phenomena of the light rays diffracted by the optical grating. The deflection structure of the input coupling region or the output coupling region can accordingly also be referred to as a diffraction structure.

For example, an optical grating can be embodied to be direction-selective or angle-selective with respect to the incident light. Thus, only light, for example a portion of the light, that is incident on an optical grating from a predetermined direction of incidence, for example at a predetermined angle, can be deflected. Light, for example a portion of the light, that is incident on the optical grating from a different direction is for example not deflected, or is less deflected, the greater the difference to the predetermined direction of incidence is. The light portion that deviates from the predetermined direction of incidence or optimum direction of incidence can consequently propagate for example unhindered through the substrate with the optical grating.

Additionally or alternatively, an optical grating can also be embodied to be wavelength-selective or frequency-selective. Thus, only light, for example a first portion of the light, having a predetermined wavelength can be deflected or diffracted by the optical grating at a specific angle of diffraction. Light, for example a second portion of the light, having a wavelength other than the predetermined wavelength is for example not deflected, or is less deflected, the greater the difference to the predetermined wavelength is. The second light portion that deviates from the predetermined wavelength or optimum wavelength can consequently propagate for example unhindered through the substrate with the optical grating. In this way, for example, at least one monochromatic light portion can be split off from polychromatic light that is incident on the optical grating. The deflection effect for the optimum wavelength is advantageously at a maximum and decreases toward longer and shorter wavelengths, for example in the manner of a Gaussian bell, or becomes weaker. For example, the deflection effect only acts on a fraction of the visible light spectrum and/or in an angular range of less than 90 degrees.

An optical grating can be produced, for example, by light exposure of a substrate, that is to say for example photolithographically or holographically. In this context, the optical grating can then also be referred to as a holographic or holographic-optical grating. Two types of holographic-optical gratings are known: surface holographic gratings (in short: SHG) and volume holographic gratings (in short: VHG). In the case of a surface holographic grating, the grating structure can be generated by optically deforming a surface structure of the substrate. Due to the modified surface structure, incident light can be deflected, for example reflected. Examples of surface holographic gratings are so-called sawtooth or blazed gratings. In contrast to this, the grating structure in the case of volume holographic gratings can be incorporated into the entire volume or part of the volume of the substrate. Surface holographic gratings and volume holographic gratings are usually frequency-selective. However, optical gratings that can diffract polychromatic light are also known. These are called multiplexed volume holographic gratings (in short: MVHG) and can be produced, for example, by changing the periodicity of the grating structure of an optical grating or by arranging a plurality of volume holographic gratings one behind the other.

A polymer, for example a photopolymer, or a film, for example a photosensitive film, for example made of plastics material or organic substances, is particularly suitable as the material of the substrate for incorporating an optical grating. Substrates that have a deflection structure for diffracting light, for example in the form of an optical grating, can also be referred to as holographic optical elements (HOE).

Due to the described embodiment of the coupling-in region and of the coupling-out region, the diffraction of the light incident on the coupling-in region toward the image capturing device, which is arranged laterally at the for example transparent carrier medium, therefore becomes possible, as a result of which the object recognition system can be designed such that the image capturing device is at least partially covered and thus arranged inconspicuously in a preferred installation position of the capturing device on the unit.

In an example embodiment, provision is made for the two-dimensional carrier medium between the coupling-in region and the coupling-out region to be formed as a transparent plate, film, or lacquer. The two-dimensional carrier medium can thus be embodied with a small thickness, which means that the width and length of the two-dimensional carrier medium is large in comparison to this small thickness of the carrier medium, which is perpendicular to the two-dimensional surface of the two-dimensional carrier medium. The two-dimensional carrier medium can have a thickness for example between half a millimeter and 5 millimeters. If the two-dimensional carrier medium is embodied in the form of a transparent film, it is additionally embodied so as to be bendable, in other words it can be deformed in a destruction-free manner, wherein destruction-free deformation is understood to mean destruction-free bending of the film by a bending radius of less than 2 centimeters. If the two-dimensional carrier medium is embodied in the form of a transparent lacquer, it can have a thickness in the micrometer range and subsequently of less than 1 millimeter. The result of this is that the two-dimensional carrier medium with the coupling-in region and the coupling-out region can be inconspicuously arranged at numerous positions, for example within a motor vehicle or at a wall, without there obscuring for example an object that is arranged behind it, with the result that for example an arrangement on a window of the motor vehicle is conceivable. In this way, the distance measurement apparatus becomes integratable into any surroundings or environment.

In an advantageous embodiment, provision is made for the evaluation device to be designed to determine, as provided object data, a spatial position of the captured object in relation to a reference point of the object recognition system and/or a three-dimensional shape of the captured object, for example by use of photogrammetry. For example, if respective capturing devices with for example respective image capturing devices are arranged at various positions within a vehicle interior, it is possible to capture for example the driver of the motor vehicle from different viewing angles. With the aid of the image data provided by a plurality of image capturing devices, the evaluation device can ultimately determine where the driver is located in relation to a reference point of the object recognition system, such as in relation to the surface of the carrier medium of one of the capturing devices. It is thus possible for example to determine coordinates of the captured object. Alternatively, or additionally, it is possible to also determine a three-dimensional reconstruction of the surface of the object, that is to say the shape thereof. This evaluation performed by the evaluation device takes place by use of photogrammetry, that is to say with the aid of a measurement method and an associated evaluation method of remote sensing designed to determine the spatial position or three-dimensional shape of an object from imaged representations, that is to say image data, of the latter. For this purpose, the object, which is surrounded by natural light, is usually recorded from a plurality of locations, that is to say capturing devices with respective image capturing devices, which each create an imaged presentation of the object from their respective perspective, are positioned at different positions in the surrounding area of the object.

The evaluation device is designed to provide details relating to the arrangement of the captured object in the surrounding area from the image data of the imaged presentations from different perspectives, after the respective object data were determined. This additionally makes it possible that a movement of an object through an interior can be tracked, because the spatial position of the captured object and the orientation thereof, that is to say its shape, are ascertainable for different time points and are comparable with corresponding data from other time points. It is possible hereby to reliably and quickly capture, recognize, and interpret gestures of a driver, for example.

In a further embodiment, provision is made for the object recognition system to include a light source designed to emit a light signal into the surrounding area. The light signal can be emitted for example in the form of infrared light, i.e., as an infrared light signal, or in the form of a specified light pattern. The evaluation device is designed to bring about an improvement of the image data and/or the object recognition based on the captured light signal reflected in the surrounding area, wherein the light signal emitted by the light source is coupled into the two-dimensional carrier medium through a light signal coupling-in region provided at the two-dimensional carrier medium, is guided through the two-dimensional carrier medium by internal reflection, and emerges into the surrounding area at the light signal coupling-out region provided at the two-dimensional carrier medium. For this purpose, the light signal coupling-in region is embodied in the form of a holographic element with a third deflection structure, which is designed to couple the light signal that is incident on the third deflection structure into the two-dimensional carrier medium. The light signal coupling-out region is accordingly likewise embodied in the form of a holographic element with a fourth deflection structure, which is designed to couple the transmitted light signal that is incident on the fourth deflection structure out of the two-dimensional carrier medium into the surrounding area.

The light source thus emits for example infrared light through the HOE. The infrared light can additionally be emitted in the form of a specified light pattern, that is to say as what is known as structured light. As an alternative to infrared light, light of a different wave-length range, such as for example visible light, can be emitted as a specified light pattern. Such a light pattern is frequently used for an autofocus function, that is to say for focusing the imaged presentation of the object, wherein the imaged presentation is provided in the form of the image data. This is after all a known method for automatic focusing, for example of a digital camera device. The light signal coupling-in region can here correspond to the coupling-out region, and the light signal coupling-out region can correspond to the coupling-in region. However, this is the case only if the light source is accordingly arranged for example below or laterally with respect to the carrier medium, specifically in the vicinity of the image capturing device. Alternatively, the light source can be embodied by or included as part of the unit on which the capturing device is arranged.

It is thus possible with the aid of the light signal to improve the image data. This is because the described autofocus function for the image capturing device can be provided for example by use of such a light signal. However, it is additionally possible to achieve better capturing of the object by use of the light signal, since for example more light in the visible wavelength range is available for illuminating the surrounding area if the light signal is chosen accordingly, which makes sense for example if the surrounding area is dark and contributes to improving the image quality. In addition, it is thereby possible to prevent a reduction in image quality in the event of strong stray light, because corresponding correction calculations can be performed by the evaluation device owing to the capturing of the specified reflected light signal. The light signal described can therefore ultimately contribute to an improvement of the object recognition, because the object data are based on the image data. When performing the object recognition, it is additionally possible for the evaluation device to take into account for example how the object reflects the light signal at its surface, with the result that for example information relating to the nature of the material of the object can be ascertained, as a result of which the object recognition can be improved.

In an advantageous embodiment, provision is made for the coupling-in region and the coupling-out region to be formed in one piece with the carrier medium, or for the carrier medium to be formed as a separate element from the coupling-in region and the coupling-in region. In the first case, the coupling-in region and the coupling-out region can thus, for example, be incorporated directly on a surface of the carrier medium. This means that the deflection structure can be for example etched or lasered into the surface of the carrier medium. Thus, the carrier medium itself can be embodied in the form of a HOE. In the second case, the coupling-in region, the coupling-out region, and the carrier medium can be formed separately. In this case, the coupling-in region and the coupling-out region can form, for example, at least one first element, and the carrier medium can form a second element which abuts the first element. The coupling-in region and the coupling-out region can thus be formed in at least one HOE. For example, the coupling-in region and the coupling-out region can be formed in different sections of a holographic film or plate. To fasten the film or plate to the carrier medium, the film of the plate can be adhesively bonded to the carrier medium. Alternatively, the holographic film can also be embodied in the form of an adhesive film and adhere to the surface of the carrier medium directly, that is to say without adhesive, by use of molecular forces. The capturing device with the carrier medium and the coupling-in region and coupling-out region arranged thereon can thus be produced in various ways and in particular cost-effectively.

Additionally described herein is a motor vehicle having a vehicle interior and an object recognition system, as is described herein. The at least one capturing device of the object recognition system is arranged in the vehicle interior and is oriented toward a volume of the vehicle interior through which light travels and/or toward a surrounding area of the motor vehicle. The at least one capturing device is thus arranged in the motor vehicle interior, for example, such that light from the vehicle interior is incident on the first deflection structure of the coupling-in region and is coupled into the carrier medium. The example embodiments introduced in connection with the object recognition system described herein, and the advantages thereof, correspondingly apply, where applicable, to the motor vehicle described herein. For this reason, the corresponding embodiments of the motor vehicle described herein will not be described again here. Ultimately, the capturing device is arranged in the vehicle interior, for example, such that the former is arranged for example on a unit or component in the vehicle interior, wherein the coupling-in region is arranged on the side that is arranged opposite the side on which the capturing device is attached to the surface of the unit in the vehicle interior.

An advantageous embodiment of the motor vehicle described herein makes provision for the carrier medium with the coupling-in region and the coupling-out region of the at least one capturing device to be arranged in each case at one or more of the following positions: in a screen of a display apparatus in the vehicle interior, in a rear-view mirror, in a center console, in a dashboard, in an instrument cluster, in a windshield, in a side window, in a roof window, and/or between A pillars of the motor vehicle. The capturing device in this case can be integrated into the respective component of the motor vehicle or can be attached on or to it. Various positioning possibilities within the motor vehicle are possible, for example on the windshield or on the side windows, for example whenever the carrier medium is embodied in the form of a two-dimensional transparent plate, film, or lacquer. Due to the various positions mentioned, different perspectives onto the object in the surrounding area in the vehicle interior are ultimately provided, from which in each case image data of the object are ascertained that are then taken into account for the determination of the object data. This additionally has the advantage that a direct optical path of the light to the coupling-in region is possible, as a result of which shading or distortions can be reduced. Alternatively or additionally to the positions mentioned, the carrier medium can be arranged at an application in the motor vehicle, for example at a strip or screen having lacquer on its rear side, or at a protective glass.

An advantageous embodiment of the motor vehicle described herein makes provision for the object recognition system to include at least two capturing devices, which are arranged at respectively different positions in the motor vehicle interior. In other words, at least two capturing devices are provided, which are positionable at two of the abovementioned positions, as a result of which the already described perspectives are realizable, whereupon it is ultimately possible to recognize the object in the vehicle interior and to provide object information in the form of the object data describing the recognized object, for example for a further evaluation device, for example of a driver assistance system or gesture control.

The motor vehicle described herein may be embodied in the form of a motorized vehicle, for example a passenger car or truck, or as a minibus or motorcycle.

The disclosure also includes the combinations of the features of the described embodiments as described herein.

### BRIEF DESCRIPTION OF THE DRAWINGS

These and other aspects and advantages will become more apparent and more readily appreciated from the following description of the example embodiments, taken in conjunction with the accompanying drawings of which:

FIG. 1 is a schematic illustration of a capturing device of an object recognition system; and

FIG. 2 includes schematic illustrations of a vehicle interior of a motor vehicle with an object recognition system.

### DETAILED DESCRIPTION

Reference will now be made in detail to example embodiments, the examples of which are illustrated in the accompanying drawings, wherein like reference numerals refer to like elements throughout.

The embodiments discussed below are example embodiments. In the example embodiments, the described components of the embodiments each represent individual features that should be considered independently of one another and also develop the disclosure in each case independently of one another. The disclosure is therefore also intended to include combinations of the features of the embodiments other than those illustrated. Furthermore, the described embodiments may also be supplemented by further features that have already been described.

In the drawings, identical reference signs each denote elements of identical function.

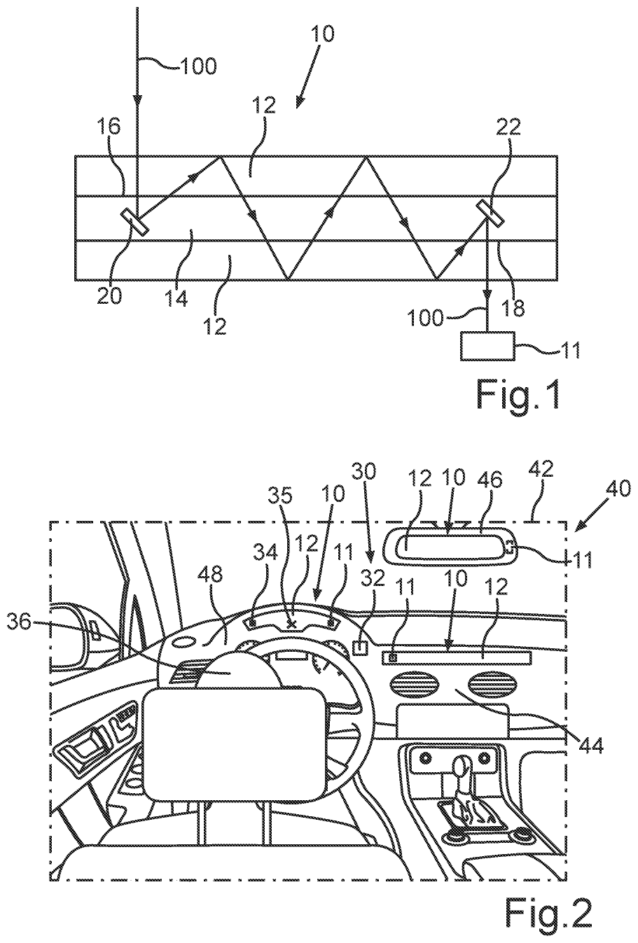

FIG. 1 illustrates a capturing device 10 for an object recognition system 30 (illustrated with the reference 30 in FIG. 2). The capturing device 10 includes a carrier medium 12 and an image capturing device 11. The carrier medium 12 is embodied in the form of a two-dimensional carrier medium 12, specifically as a transparent plate, film, or lacquer. This two-dimensional carrier medium 12 is designed to be arranged on a unit, for example in a vehicle interior 42 (illustrated with the reference sign 42 in FIG. 2). The carrier medium 2 is moreover embodied in the form of a light guide, on which a coupling-in region 16 and a coupling-out region 18 are provided.

The coupling-in region 16 is embodied in the form of a holographic element 14 with a first deflection structure 20, which is designed to couple light 100 that is incident from a surrounding area on the first deflection structure 20 into the carrier medium 12. The carrier medium 12 is embodied to transmit the coupled-in light 100 from the coupling-in region 16 to the coupling-out region 18 by internal reflection. The coupling-out region 18 is likewise embodied in the form of a holographic element 14 and with a second deflection structure 22, which is designed to couple the transmitted light 100 that is incident on the second deflection structure 22 out of the two-dimensional carrier medium 12. The image capturing device 11 is embodied to capture the light 100 that is coupled out and to provide it in the form of image data that correlate with the captured light 100.

The coupling-in region 16 and the coupling-out region 18 have at least one optical grating as the respective deflection structure 20, 22, which grating is embodied for example in the form of a volume holographic grating or a surface holographic grating. The coupling-in region 16 and the coupling-out region 18 are additionally formed in one piece with the carrier medium 12. Alternatively, the carrier medium 12 is embodied as a separate element from the coupling-in region 16 and the coupling-out region 18.

FIG. 2 illustrates the vehicle interior 42 of a motor vehicle 40. The object recognition system 30, which in this example includes three capturing devices 10, is located therein. These capturing devices 10 are arranged in a center console 44, in a rear-view mirror 46, and in a dashboard 48 of the motor vehicle 40. In addition to the respective capturing devices 10 and the respective at least one image capturing device 11, the object recognition system 30 includes a central evaluation device 32. The evaluation device 32 is embodied to capture, taking into account the image data provided by the respective image capturing devices 11, an object 36 in the surrounding area, to recognize the captured object 36, taking into account an object recognition criterion, and to provide object data describing the recognized object 36. The provided object data that can be determined are for example a spatial position of the captured object 36 in relation to a reference point of the object recognition system 30 and/or a three-dimensional shape of the captured object 36. This can be done for example by use of photogrammetry. The object 36 that can be captured here by the object recognition system 30 is for example a driver of the motor vehicle 40. The object 36 is therefore drawn in the form of a driver in FIG. 2.

The respective image capturing device 11 can be arranged, for example, at a lateral region of the respective capturing device 10. However, as is shown in the example of the capturing device 10 in the rear-view mirror 46, it can be arranged in a lateral frame of the unit on which the two-dimensional carrier medium 12 is arranged, which means that it is not visible to the driver.

The object recognition system 30 additionally includes a light source 34, which is designed to emit a light signal into the surrounding area, that is to say into the vehicle interior 42. The light signal can be emitted for example in the form of infrared light, i.e. as an infrared light signal and/or in the form of a specified light pattern. The evaluation device 32 is designed to effect, based on the captured light signal that has been reflected in the surrounding area, an improvement of the image data and/or the object recognition. The light source 34 may be arranged in relation to the capturing device 10 such that the light signal emitted by the light source 34 is coupled into the carrier medium 12 through a light signal coupling-in region, is guided through the carrier medium 12 by internal reflection, and emerges into the surrounding area at a light signal coupling-out region. The light signal coupling-in region is here for example the same as the coupling-out region 18, and the light signal coupling-out region is the same as the coupling-in region 16. The light signal coupling-out region is marked in FIG. 2 by way of example with a cross 35.

Alternative positions at which the at least one capturing device 10 can be arranged in the vehicle interior 42 may include: in a screen of a display apparatus in the vehicle interior 42, in an instrument cluster, in a wind-shield, in a side window, between two A pillars of the motor vehicle 40.

The object recognition system 30 may include at least two capturing devices 10, that is to say for example, as in the described example, three capturing devices 10. The latter are arranged at respectively different positions in the vehicle interior 42.

Overall, the examples show how recognition of objects 36 in a vehicle interior 42 can be provided by the object recognition system described herein. For this purpose, a holographic optical element (HOE) is used for recognizing the objects 36 in the vehicle interior 42. The object recognition system 30 that is designed as described herein can be arranged inconspicuously in an application strip, that is to say for example in the center console 44, in the dashboard 48, or in the instrument cluster, or on the screen of the display apparatus in the vehicle interior 42, in the windshield, in a side window, and/or on the rear-view mirror 46. The object recognition system 30 serves for recognizing objects 36. In addition to the installation possibilities, another advantage here is that a beam path, that is to say the beam path of the light 100, is kept parallel and thus shading or distortions can be prevented. Furthermore, the light signal from the light source 34 can be input into the carrier medium 12 and be coupled out of it in the direction of the surrounding area in order to utilize an improvement in the recording quality achievable thereby in the image data determination and/or the object recognition. A further advantage arises from the use of a variety of illumination types in order to ascertain from which material an article is made and/or what temperature or what surface properties the article has. For example, a light signal of infrared light is suitable for such purposes.

This may be achieved by positioning a holographic optical element in the center console, the dashboard, the screen of the display apparatus, the instrument cluster, and/or the rear-view mirror 46 in order to ultimately be able to capture and evaluate the objects 36 brought along by the driver and even the driver as the object 36. Here, a plurality of views from different perspectives are advantageous because these can be used for the reconstruction, for example via photogrammetry. It is also possible for a variety of systems to be combined in order to make possible simultaneous capturing of an object 36 in the vehicle interior 42 or, for example, to track the movement of the object 36 through the vehicle interior 42. To improve capturing, further light sources 34 or capturing methods using for example light patterns or infrared light can be used. These also allow capturing of high-quality image data and object data even if the vehicle interior 42 is dark or a strong stray light in the vehicle interior 42 is observed.

A description has been provided with reference to various examples, but it will be understood that variations and modifications can be effected within the spirit and scope of the claims which may include the phrase “at least one of A, B, and C” as an alternative expression that means one or more of A, B, and C may be used, contrary to the holding in Superguide v. DIRECTV, 358 F3d 870, 69 USPQ2d 1865 (Fed. Cir. 2004). That is the scope of the expression “at least one of A, B, and C” is intended to include all of the following: (1) at least one of A, (2) at least one of B, (3) at least one of C, (4) at least one of A and at least one of B, (5) at least one of A and at least one of C, (6) at least one of B and at least one of C, and (7) at least one of A, at least one of B, and at least one of C. In addition, the term “and/or” includes a plurality of combinations of relevant items or any one item among a plurality of relevant items. That is, the scope of the expression or phrase “A and/or B” includes all of the following: (1) the item “A”, (2) the item “B”, and (3) the combination of items “A and B”.

1.-9. (canceled)

10. An object recognition system, comprising:
a two-dimensional carrier medium configured as a light guide, and on which a coupling-in region and a coupling-out region are disposed, wherein
the coupling-in region is configured as a holographic element including a first deflection structure configured to couple light that is incident from a surrounding area on the first deflection structure into the two-dimensional carrier medium,
the two-dimensional carrier medium is configured to transmit the light coupled into the two-dimensional carrier medium from the coupling-in region by internal reflection to the coupling-out region, and
the coupling-out region is configured as a holographic element including a second deflection structure configured to couple light transmitted to the coupling-out region via the two-dimensional carrier medium that is incident on the second deflection structure, out of the two-dimensional carrier medium;
an image capturing device configured to capture the light that is coupled out of the two-dimensional carrier medium via the coupling-out region, and to provide the light coupled out of the two-dimensional carrier medium in a form of image data which correlates with the light coupled out of the two-dimensional carrier medium; and
an evaluation device configured to capture an object in the surrounding area based on the image data, to recognize the object based on an object recognition criterion, and to provide object data describing the recognized object.

11. The object recognition system as claimed claim 10, wherein
the coupling-in region includes at least one optical grating as the first deflection structure, and
the coupling-out region includes at least one optical grating as the second deflection structure.

12. The camera apparatus as claimed in claim 11, wherein
the at least one optical grating of the coupling-in region includes a surface holographic grating or a volume holographic grating, and
the at least one optical grating of the coupling-out region includes the surface holographic grating or the volume holographic grating.

13. The object recognition system as claimed in claim 10, wherein the two-dimensional carrier medium is configured as a transparent plate, film, or lacquer.

14. The object recognition system as claimed in claim 10, wherein
the evaluation device is configured to determine the object data describing the recognized object, and
the object data includes a spatial position of the object in relation to a reference point of the object recognition system and/or a three-dimensional shape of the object.

15. The object recognition system as claimed in claim 14, wherein the evaluation device is configured to determine the object data describing the recognized object by photogrammetry.

16. The object recognition system as claimed in claim 10, further comprising:
a light source configured to emit a light signal into the surrounding area,
wherein
the light signal emitted by the light source is coupled into the two-dimensional carrier medium through a light signal coupling-in region, then guided through the two-dimensional carrier medium by internal reflection, and output to the surrounding area at a light signal coupling-out region, and
the evaluation device is configured to effect, based on the light signal emitted by the light source and output to the surrounding area, an improvement of the image data and/or the object recognition.

17. The object recognition system as claimed in claim 16, wherein the light signal includes infrared light and/or a specified light pattern.

18. The object recognition system as claimed in claim 10, wherein
the coupling-in region and the coupling-out region are formed as one piece with the two-dimensional carrier medium, or
the two-dimensional carrier medium is formed as a separate element from the coupling-in region and the coupling-out region.

19. A motor vehicle, comprising:
a vehicle interior; and
an object recognition system, including:
a two-dimensional carrier medium configured as a light guide, and on which a coupling-in region and a coupling-out region are disposed, wherein
the coupling-in region is configured as a holographic element including a first deflection structure configured to couple light that is incident from a surrounding area on the first deflection structure into the two-dimensional carrier medium,
the two-dimensional carrier medium is configured to transmit the light coupled into the two-dimensional carrier medium from the coupling-in region by internal reflection to the coupling-out region, and
the coupling-out region is configured as a holographic element including a second deflection structure configured to couple light transmitted to the coupling-out region via the two-dimensional carrier medium that is incident on the second deflection structure out of the two-dimensional carrier medium,
an image capturing device disposed in the vehicle interior and configured to capture the light that is coupled out of the two-dimensional carrier medium via the coupling-out region, and to provide the light coupled out of the two-dimensional carrier medium in a form of image data which correlates with the light coupled out of the two-dimensional carrier medium, and
an evaluation device configured to capture an object in the surrounding area based on the image data, to recognize the object based on an object recognition criterion, and to provide object data describing the object.

20. The motor vehicle as claimed in claim 19, wherein the two-dimensional carrier medium is disposed at at least one of the following positions:
in a screen of a display apparatus in the vehicle interior,
in a rear-view mirror in the vehicle interior,
in a center console in the vehicle interior,
in a dashboard in the vehicle interior, in an instrument cluster in the vehicle interior,
in a windshield of the motor vehicle,
in a side window of the motor vehicle,
in a roof window of the motor vehicle, and between two A pillars of the motor vehicle.

21. The motor vehicle as claimed in claim 19, wherein the object recognition system includes at least two capturing devices disposed at respectively different positions in the vehicle interior.

22. The motor vehicle as claimed in claim 19, wherein the image capturing device is oriented toward a volume of the vehicle interior and/or toward a surrounding area of the motor vehicle.
